(19) United States
(12) Patent Application Publication
(10) Pub. No.: US 2003/0167845 A1
(43) Pub. Date: Sep. 11, 2003

(54) Defect identification in bodies consisting of brittle material

(76) Inventors: Stefan Maetschke, Altdorf (DE); Thomas Voelkel, Bad Steben (DE)

Correspondence Address: STAAS & HALSEY LLP, SUITE 700, 1201 NEW YORK AVENUE, N.W., WASHINGTON, DC, 20005, US

(21) Appl. No.: 10/363,917

(22) PCT Filed: Jul. 10, 2001
(86) PCT No.: PCT/DE02/02529

(30) Foreign Application Priority Data
Jul. 10, 2001 (DE) 101 33 510.5

(51) Int. Cl. G01H 13/00; G01N 29/12

(52) U.S. Cl. 73/579; 73/12.01

(57) ABSTRACT

The invention relates to a nonlinear method that permits simple, fast and accurate detection of defects in a body made from brittle materials. In the case of the method, at least two temporally offset operations (A, B) are used such that the body is set vibrating (1a, 1b) with a different intensity, a vibrational response of the body in the time domain is picked up (2a, 2b), the vibrational response is normalized (3a, 3b), the beginning of the vibration is determined (4a, 4b) and a section of the vibrational response is determined (5a, 5b) whose start is formed by the previously determined beginning of the vibration, and which has a specific length, a correlation coefficient of the sections of the respective vibration responses of the at least two operations being formed as feature value for the detection of defects (6).

The invention relates to a method for detecting defects in bodies made from brittle materials, for example from glass or ceramic.

In addition to visual methods, vibroacoustic methods are also used for detecting errors in bodies from brittle materials, in particular for detecting cracks in roof tiles. For this purpose, a roof tile is set vibrating with the aid of a mechanism and the vibration is picked up and subsequently evaluated. The evaluation can be performed in this case in principle with the aid of two different methods. In the case of the nonlinear methods described in the specialist article by Johnson, P., The new wave in Acoustic Testing, Materials World, September 1999, a tile is excited at least twice with a different intensity or different frequencies. If the tile is defective, a nonlinear displacement of the resonant frequencies can be observed as a function of the excitation, while the resonant frequencies exhibit no displacement in the case of an acceptable tile. This effect remains out of account in the case of linear methods (for example by means of measuring the root-mean square value of the vibration signal). It is an advantage of the linear methods, in contrast, that a single strike of the tile suffices. It is disadvantageous that linear methods have, as a rule, to be specifically adapted for each type of tile (shape, color) (feature, threshold values), in order to ensure correct detection of defective tiles. If the above-named nonlinear method is used for testing tiles, the tile must be struck several times. For each strike, the vibration of the tile must be picked up, the Fast Fourier Transformation (FFT) calculated, the resonant frequencies identified, and the displacement of the resonant frequencies determined. In particular, the calculation of the FFT and the identification of the resonant frequencies are expensive in this case and affected by inaccuracies, this being reflected in the quality of the detection of cracks.

It is the object of the invention to specify a nonlinear method that permits simple, quick and accurate detection of defects in a body made from brittle materials.

This object is achieved by means of a method for detecting defects in a body made from brittle materials, in the case of which method at least two temporally offset operations are used such that the body

is set vibrating with a different intensity,

a vibrational response of the body in the time domain is picked up

the vibrational response is normalized

the beginning of the vibration is determined and

a section of the vibrational response is determined whose start is formed by the previously determined beginning of the vibration, and which has a specific length,

a correlation coefficient of the sections of the respective vibration responses of the at least two operations being formed as feature value for the detection of defects.

The method according to the invention is based on the above-named nonlinear methods, but is distinguished by greater simplicity, higher accuracy and quicker calculation. The body made from brittle material is set vibrating with a different intensity in (at least) two temporally offset operations, also denoted below as striking operations, and the vibrational responses of the body are picked up. Subsequently, the two vibrational responses are normalized (for example with mean value=0, standard deviation=1), and the beginning (the starting point) of the actual vibration is determined in each case. Proceeding from the starting point found, a short part (typically 500 to 2000 measured values) of the signal—the pickup of the vibrational response—is excised, and the correlation coefficient is determined between the section from the first striking operation and the section from the second striking operation. The method according to the invention operates directly in the time domain on a short section of the vibrational response, and determines the correlation between the vibrational responses of two or more striking operations. The inaccuracies in the determination of the displacement of the resonant frequencies and the calculation of the FFT in the case of the above-named nonlinear method are thereby avoided. Since only a portion of the vibrational response is required for the evaluation, the two strikes can be performed very quickly one after another, and the analyzing time can be shortened by comparison with previously known methods.

The beginning of the vibration is determined in a simple way by determining, proceeding from the start of the pickup of the vibrational response, that instant at which the value of the vibrational response exceeds a specific threshold value (for example twice the standard deviation) for the first time. In the case of exact triggering, it is possible to dispense with determining the starting instants by calculation, and the beginning of the vibration is automatically determined with the aid of the instant at which the body is set vibrating. As a rule, however, the trigger mechanism is less accurate than the computational method.

The detection of a defect in the body is advantageously performed by virtue of the fact that the feature value for the detection of defects is compared with a feature value, previously determined in the same way, of a body without defects, a feature value that is lower by comparison with the feature value of the body without defects indicating a defect of the body. In the case of a defective body, this feature value is lower (for example r=0.36) than in the case of a body without defects (r=0.67), since here the correlation between first and second striking operations is lower.

Because the determination of the starting point is affected by a certain error, it is proposed that further sections of the vibrational response be determined whose start is shifted in each case from the start of the previously determined section and which have a specific length, a mean value being formed as feature value for the detection of defects from correlation coefficients of the further sections of the respective vibrational responses of the at least two operations. Thus, for example, a further four correlation coefficients are calculated that result from the virtual displacement of the starting points by one or two measured values to the left and to the right. The final feature value that is used to detect defective bodies is then calculated from the mean value of the five correlation coefficients.

The proposed method can also be carried out when the body is set vibrating with a different frequency, instead of a different intensity in at least two temporally offset operations. The vibrational response of the body is typically picked up acoustically or by acceleration sensors. Bodies made from brittle materials are bodies made from glass, from ceramic materials, and the like. Typical defects that are detected by the method are cracks and irregularities in the structure of the material. The method is particularly suitable for detecting cracks in tiles.

It is an advantage of the method proposed that the two strikes can be performed very quickly one after another, since in each case only a short section of the vibrational response is required for the evaluation. There is no need to await the complete decay of the signal.

The invention is described and explained in more detail below with the aid of the exemplary embodiment illustrated in the figures, in which:

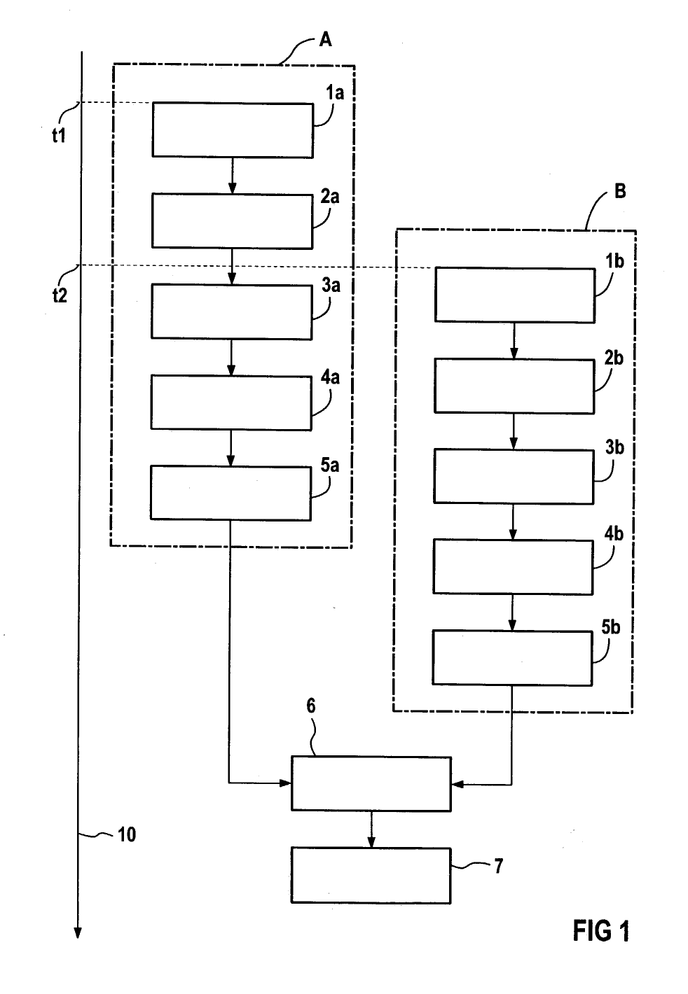

FIG. 1 shows a flowchart of the method for detecting defects in a body made from brittle materials with the aid of two temporally offset striking operations,

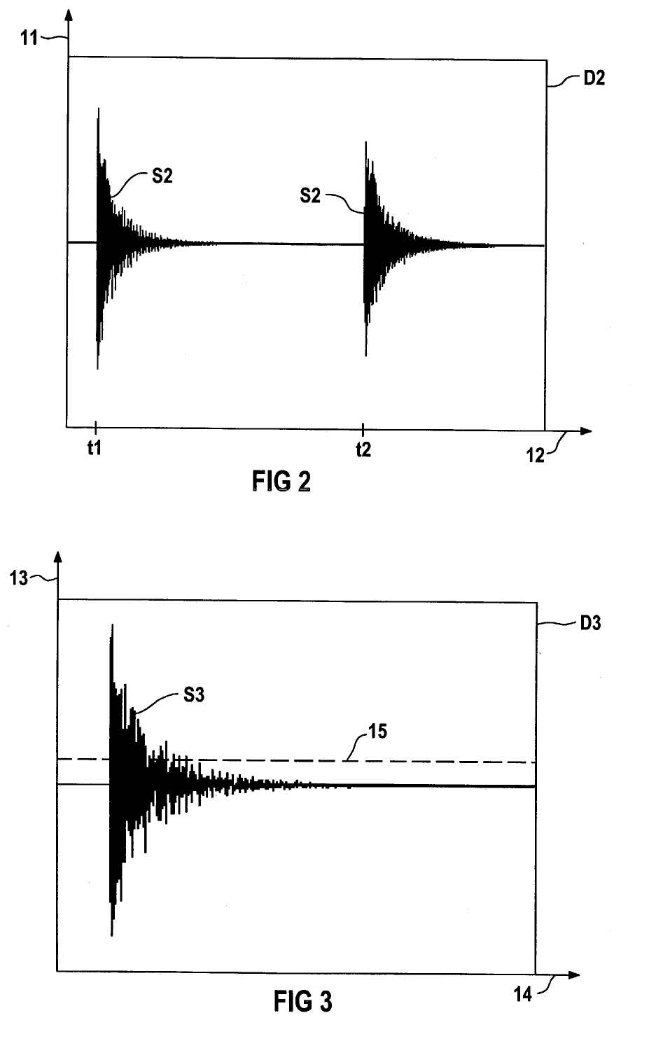

FIG. 2 shows typical vibrational responses of a body in the case of a twofold strike of the body,

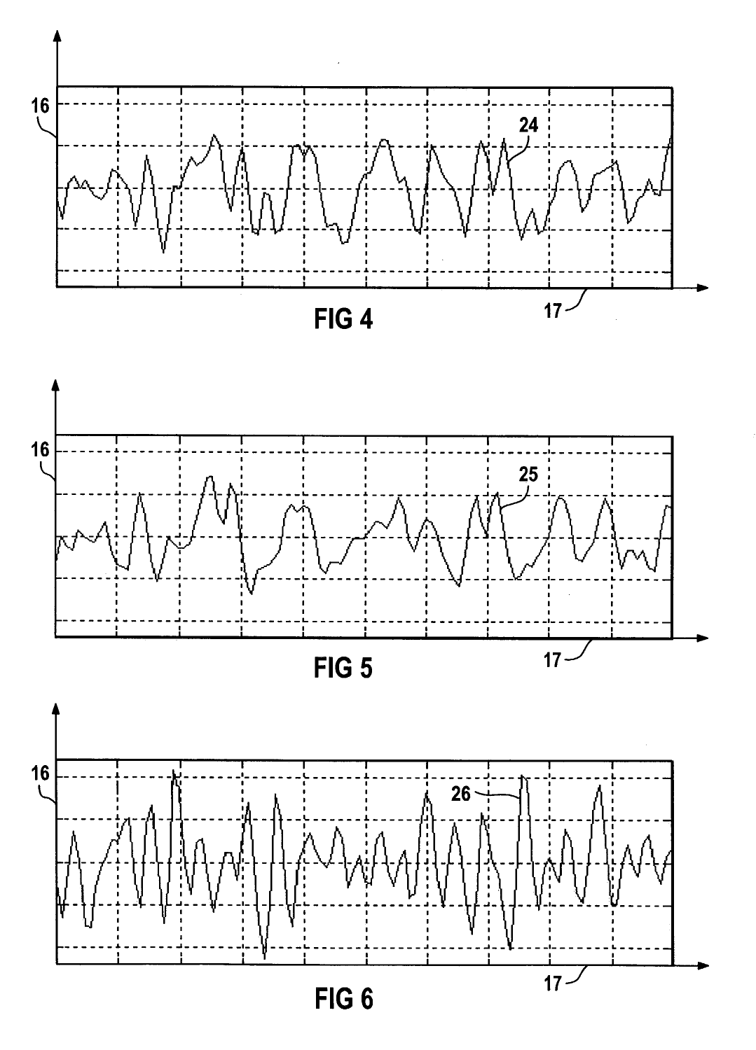

FIG. 3 shows an example of a normalized vibrational response with the threshold value drawn in,

FIG. 4 shows a section of the vibrational response of a body without defects after a hard strike,

FIG. 5 shows a section of the vibrational response of the body without defects after a soft strike,

FIG. 6 shows a section of the vibrational response of a defective body after a hard strike,

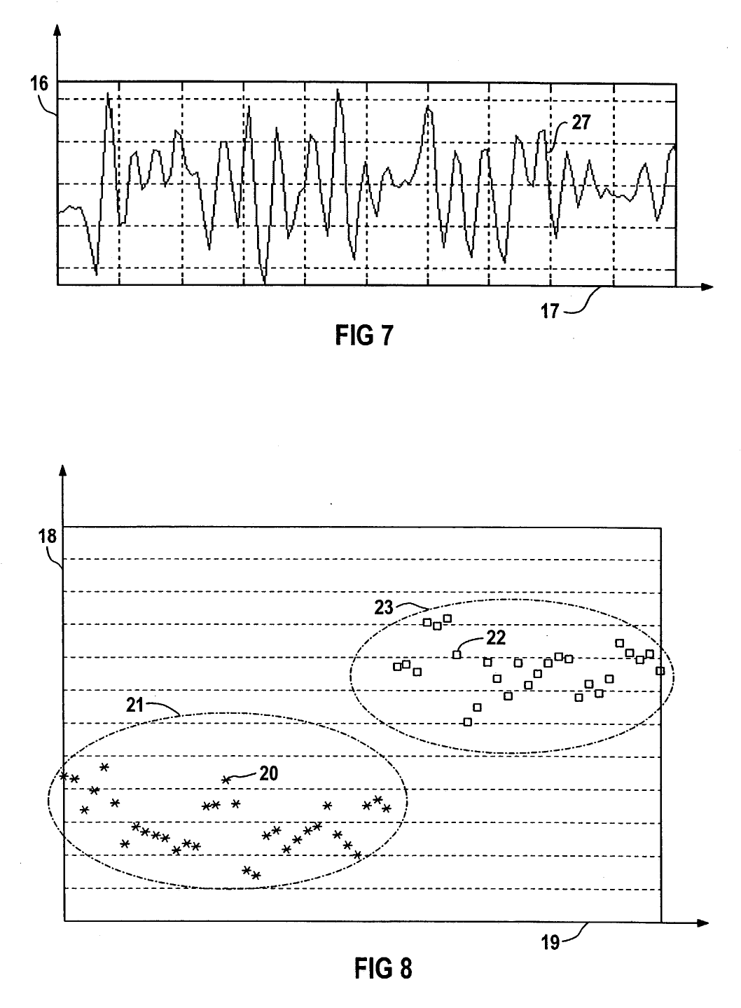

FIG. 7 shows a section of the vibrational response of a defective body after a soft strike, and

FIG. 8 shows a graphic illustration of the values of mean correlation coefficients, determined with the aid of the method described, for bodies without detects and defective bodies.

FIG. 1 shows by way of example a flowchart of the method for detecting defects in a body made from brittle materials with two temporally offset striking operations A, B. A perpendicular time axis 10 is illustrated on which a first instant t1 denotes the beginning of a first operation A, and a second instant t2 denotes the beginning of a second operation B. The operation A comprises five steps of which the temporal sequence is denoted by the reference 1a to 5a, while the operation B correspondingly comprises five temporally offset steps 1b to 5b. The two operations A, B merge into a common path whose steps are denoted by the references 6 and 7.

The cycle of the proposed method is described and explained by way of example below with the aid of FIG. 1. The method is suitable for detecting defects on bodies made from brittle materials, the aim in the exemplary case being to use it to detect cracks in roof tiles. The roof tile therefore serves as a typical example of a body made from brittle materials, but the statements relating to the roof tile can certainly be transferred to other brittle bodies, for example made from glass or further ceramic materials. The first operation A of the method begins at instant t1 with the first step 1a, while the second operation B begins correspondingly at instant t2 with the first step 1b. The two operations A, B are described together below, since they have equivalent steps—albeit temporally offset. The roof tile is set vibrating with the aid of a suitable mechanism in step 1a, 1b. It is, for example, struck with a specific intensity by means of a striking mechanism. The vibrations that the tile thereupon executes, that is to say its vibrational response, are picked up in the second step 2a, 2b via acoustic pickups or via acceleration sensors. In the following third step 3a, 3b, the vibrational response is normalized (for example with mean value=0, standard deviation=1), and in the fourth step 4a, 4b the beginning (the starting point) of the actual vibration is determined in each case. Proceeding from the starting point found, a short portion (typically a sequence with five hundred to two thousand measured values) of the signal—that is to say the picking up of the vibrational response—is excised. After expiry of the fifth step 5a, 5b, a section from the vibrational response of the first operation A or the second operation B, respectively, is therefore present in the exemplary embodiment. The two operations A, B differ from one another not only with regard to their starting instant, but also with reference to the intensity with which the striking mechanism sets the tile vibrating in each case. In the first operation A, the tile is struck hard in the first step 1a, in the first step 1b, following thereupon in time, of the second operation B, the same tile is struck in a comparatively soft fashion. The temporal difference between the instants t1 and t2 is selected such that the beginning of the first vibrational response can be recorded before the second vibrational excitation occurs. It is not necessary to wait until the first vibration has completely decayed before beginning with the second operation B. The two sections present of the normalized vibrational responses are now correlated with one another in the sixth step 6 of the method. The calculated result of the correlation is a correlation coefficient that is a measure of the correspondence between the two vibrational responses. The correlation coefficient serves as feature value for the detection of defects. Intact roof tiles without defects have a higher value of the correlation coefficient than do defective roof tiles, for example roof tiles with a crack. Given knowledge of the typical value range in which the correlation coefficient that can be determined by the proposed method is situated given tiles without defects, it is possible to compare a further determined correlation coefficient with this typical value range, and thus to make a statement as to whether the tile tested with the aid of the method has no defect (value of the correlation coefficient within the typical value range), or is defective (value of the correlation coefficient below the typical value range). This test for defectiveness is carried out in the seventh step 7 of the method. The processing of steps 3a, 3b to 7 is performed in a computer that is fed as signals the vibrational responses picked up. The tiles judged as being defective with the aid of the method described are subjected in further steps (not illustrated here graphically) to additional visual monitoring, or rejected directly as unusable.

FIG. 2 shows typical vibrational responses S2 of the tile when the tile is struck twice. In the diagram D2 illustrated in FIG. 2, the amplitude of the signal of the vibrational responses S2 is plotted on the vertical axis 11, while the time is plotted on the horizontal axis 12. The instants t1, t2 already represented in the flowchart in FIG. 1 are denoted on the horizontal axis 12 with the same reference numerals. At the first instant t1, the tile is set vibrating, the amplitude of which vibration has almost entirely decayed at instant t2 in the exemplary case, the tile then being set vibrating for the second time. Since the tile is struck harder on the first occasion than on the second, the maximum achieved amplitude of the vibrational response S2 is visibly greater on the first occasion.

An example of a normalized vibrational response S3 with the threshold value 15 drawn in is illustrated in a diagram D3 in FIG. 3. The normalized amplitude of the vibrational response S3 is plotted on the vertical axis 13, and the time is plotted on the horizontal axis 14. In the fourth step 4a, 4b of the method, the beginning of the vibrational response S3 is determined, for example, by virtue of the fact that the instant is determined at which the normalized value of the vibrational response S3 exceeds the previously established threshold value 15 for the first time. The threshold value 15 is established in the exemplary embodiment at the value of twice the standard deviation.

FIG. 4 and FIG. 5 show sections 24, 25 from vibrational responses of a tile without defects, FIG. 4 for a hard strike, and FIG. 5 for a subsequent soft strike. FIG. 6 and FIG. 7 show corresponding sections 26, 27 from vibrational responses of a defective tile, once again for a hard strike (FIG. 6) and for a soft strike (FIG. 7). The normalized amplitude of the vibrational responses is plotted in each case in FIG. 4 to FIG. 7 on the vertical axis 16, and the time is plotted on the horizontal axis 17. The sections 24 to 27, reproduced graphically in FIG. 4 to FIG. 7 from vibrational responses are the result of the fifth step 5a, 5b of the method. The sections are present in the method as data volumes, for example in the form of tables. These data volumes are correlated with one another in the sixth step 6. It may be seen with the naked eye that the sections 24, 25 of the vibrational responses of the tile without defects are more strongly correlated with one another than the corresponding sections 26, 27 of the defective tile. This is also the result of the calculation of the respective correlation coefficients with the aid of the data volumes on which the graphical representations are based. The correlation coefficient of the vibrational responses of the tile without defects has the value 0.67 in the example, whereas the correlation coefficient of the vibrational responses of the defective tile is only 0.36, that is to say substantially lower.

Because the determination of the starting point of the vibration in the vibrational responses is affected by a certain error, there are also calculated in the exemplary embodiment four further correlation coefficients, which result from the virtual displacement of the starting points by one or by two measured values to the left and to the right. In the example, the measuring signal of the vibrational response is sampled at discrete instants, that is to say temporally equidistant measured values are present. The final feature value 20, 22 that is used to detect defective tiles is calculated in this case from the mean value of the five calculated correlation coefficients. These feature values 20, 22 are plotted graphically in FIG. 8. The averaged correlation coefficient of the respective feature value 20, 22 is plotted on the vertical axis 18, while the number of the examined tile is plotted on the horizontal axis 19. The feature values 20, 22 of sixty different tiles are represented as a whole. Located in the region denoted by the reference 21 are the feature values 20 of thirty three defective tiles, by contrast the feature values 22 of twenty seven tiles without defects are located in the region denoted by the reference numeral 23. It can clearly be seen that the averaged correlation coefficient of the vibrational responses of the tiles without defects has substantially higher values than the corresponding correlation coefficient of the defective tiles. The feature values 20, 22 determined with the aid of the method described can therefore be used to distinguish between tiles without defects and defective ones.

In summary, the invention therefore relates to a nonlinear method that permits a simple, quick and accurate detection of defects in a body made from brittle materials. In the case of the method, the body is set vibrating 1a, 2b with a different intensity in at least two temporally offset operations A, B, a vibrational response of the body is picked up in the time domain, 2a, 2b the vibrational response is normalized 3a, 3b, the beginning of the vibration is determined 4a, 4b and a section of the vibrational response is determined 5a, 5b whose start is formed by the previously determined beginning of the vibration, and which has a specific length, a correlation coefficient of the sections of the respective vibration responses of the at least two operations being formed as feature value for the detection of defects 6.

1. A method for detecting defects in a body made from brittle materials, in the case of which method at least two temporally offset operations (A, B) are used such that the body
is set vibrating (1a, 1b) with a different intensity,
a vibrational response of the body in the time domain is picked up (2a, 2b)
the vibrational response is normalized (3a, 3b)
the beginning of the vibration is determined (4a, 4b) and
a section of the vibrational response is determined (5a, 5b) whose start is formed by the previously determined beginning of the vibration, and which has a specific length,
a correlation coefficient of the sections of the respective vibration responses of the at least two operations being formed as feature value for the detection of defects (6).

2. The method as claimed in claim 1, characterized in that in order to determine the beginning of the vibration there is determined, proceeding from the start of the pickup of the vibrational response, an instant at which a value of the vibrational response exceeds a specific threshold value (15) for the first time.

3. The method as claimed in claim 1 or 2, characterized in that the feature value for the detection of defects is compared with a feature value, previously determined in the same way, of a body without defects, a feature value that is lower by comparison with the feature value of the body without defects indicating a defect of the body.

4. The method as claimed in one of the preceding claims, characterized in that further sections of the vibrational response are determined whose start is shifted in each case from the start of the previously determined section and which have a specific length, a mean value being formed as feature value for the detection of defects from correlation coefficients of the further sections of the respective vibrational responses of the at least two operations.

5. The method as claimed in one of the preceding claims, characterized in that the vibrational response of the body is picked up acoustically.

6. The method as claimed in one of the preceding claims, characterized in that the vibrational response of the body is picked up by acceleration sensors.

7. The method as claimed in one of the preceding claims, characterized in that the method is used to detect defects in a body made from glass.

8. The method as claimed in one of the preceding claims, characterized in that the method is used to detect defects in a body made from ceramic materials.

9. The method as claimed in one of the preceding claims, characterized in that the beginning of the vibration is determined automatically with the aid of the instant at which the body is set vibrating.

10. The method as claimed in one of the preceding claims, characterized in that the body is set vibrating with a different frequency in at least two temporally offset operations.
